(19) United States
(12) Patent Application Publication
(10) Pub. No.: US 2019/0376411 A1
(43) Pub. Date: Dec. 12, 2019

(54) SYSTEM AND METHOD FOR TURBOMACHINERY BLADE DIAGNOSTICS VIA CONTINUOUS MARKINGS

(71) Applicant: General Electric Company, Schenectady, NY (US)

(72) Inventors: Michael Allen Ball, Greenville, SC (US); Kurt Kramer Schleif, Greenville, SC (US)

(21) Appl. No.: 16/005,607

(22) Filed: Jun. 11, 2018

(51) Int. Cl. F01D 21/00; G01B 11/16

(52) U.S. Cl. CPC F01D 21/003; G01B 11/16; F05D 2260/83; F05D 2260/80; F05D 2220/32

(57) ABSTRACT

In one embodiment, a blade monitoring system is provided. The blade monitoring system includes a processor. The processor is configured to receive a sensor signal from a sensor configured to observe a blade of the turbomachinery, and to derive a measurement based on a marking disposed on the blade of the turbomachinery, wherein the marking comprises a continuous feature. The processor is also configured to display the measurement to an operator of the turbomachinery.

### BACKGROUND

The subject matter disclosed herein relates to turbomachinery, and more specifically, to a system and method for turbomachinery blade prognostics and diagnostics via continuous markings.

Certain turbomachinery, such as gas turbine systems, generally include a compressor, a combustor, and a turbine. The compressor compresses air from an air intake, and subsequently directs the compressed air to the combustor. In the combustor, the compressed air received from the compressor is mixed with a fuel and is combusted to create combustion gases. The combustion gases are directed into the turbine. In the turbine, the combustion gases pass across turbine blades of the turbine, thereby driving the turbine blades, and a shaft to which the turbine blades are attached, into rotation. The rotation of the shaft may further drive a load, such as an electrical generator, that is coupled to the shaft. The flow and pressure of the fluids into the turbine may be dependent on the turbine blades. However, components of the gas turbine system may experience wear and tear during use. It would be beneficial to provide prognostic and diagnostic information for the blades of components of the gas turbine system.

### BRIEF DESCRIPTION

Certain embodiments commensurate in scope with the present disclosure are summarized below. These embodiments are not intended to limit the scope of the claimed disclosure, but rather these embodiments are intended only to provide a brief summary of possible forms of the disclosure. Indeed, the disclosure may encompass a variety of forms that may be similar to or different from the embodiments set forth below.

In a first embodiment, a blade monitoring system is provided. The blade monitoring system includes a processor. The processor is configured to receive a sensor signal from a sensor configured to observe a blade of the turbomachinery, and to derive a measurement based on a marking disposed on the blade of the turbomachinery, wherein the marking comprises a continuous feature. The processor is also configured to display the measurement to an operator of the turbomachinery.

In a second embodiment, a turbomachinery system is provided. The turbomachinery system includes a blade configured to rotate during operations of the turbomachinery system, and a sensor configured to observe the blade of the turbomachinery. The turbomachinery system also includes a blade monitoring system. The blade monitoring system includes a processor. The processor is configured to receive a sensor signal from a sensor configured to observe a blade of the turbomachinery. The processor is also configured to derive a measurement based on a marking disposed on the blade of the turbomachinery, wherein the marking comprises a continuous feature; and to display the measurement to an operator of the turbomachinery.

In a third embodiment, a method is provided. The method includes receiving, via a processor, a sensor signal from a sensor configured to observe a blade of a turbomachinery. The method also includes deriving, via the processor, a measurement based on a marking disposed on the blade of the turbomachinery, wherein the marking comprises a continuous feature; and displaying the measurement to an operator of the turbomachinery.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a gas turbine system having a gas turbine equipped with blades and a blade monitoring system for monitoring of the blades;

FIG. 2 is a front view of an embodiment of a stage of the gas turbine of FIG. 1, having multiple blades;

FIG. 3 is a detail front view of an embodiment of a single blade-observing sensor disposed in a stationary casing housing the stage of FIG. 2;

FIG. 4 is a detail front view of an embodiment of the sensor of FIG. 3, showing a shift in sensed points on a blade;

FIG. 5 is a view of an embodiment of a blade of the gas turbine system of FIG. 1 showing a shift in sensed points on the blade;

FIG. 6 is a detail front view of an embodiment of blades having various markings having discrete features suitable for determining certain blade properties and/or conditions;

FIG. 7 illustrates an embodiment of impingement points on a blade that may then result in an embodiment of a light intensity graph;

FIG. 8 illustrates an embodiment of shifted impingement points on a blade that may then result in an embodiment of a shifted light intensity graph; and

FIG. 9 is a flowchart of an embodiment of a process suitable for deriving certain information via the blade markings of FIG. 6.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The techniques described herein provide for techniques to “encode” or otherwise mark individual blades in turbomachinery, such as blades in a gas turbine engine, via markings that may be placed on a blade portion (e.g., edge). The markings may include reflective and/or magnetic markings for use with sensors, such as optical laser-based sensors and/or magnetic sensors. A location at which a laser light (or magnet) is interrupted and reflected by a passing blade may change over time, potentially introducing error in the measurement. To determine where on the passing blade the laser light is being interrupt and reflected, a defined subset of blades are painted with a stripe containing a continuously varying feature, such as a continuous taper, that causes the reflected light (or magnets) to respond differently with varying radial location on the blades. The continuous taper may be created by masking a portion of the area being painted on the blade surface.

The painted pattern on all (or some) blades may be positioned at a precise, known location on the surface of the blade. When an operator is monitoring reflected light signal width in real-time, they will observe the blade's reflected light intensity width as significantly different and distinguishable from previous revolutions when at different radial position. The continuous taper of paint on the blade surfaces is essentially “coding” the rotating blades such that the operator may determine where on the blade surface the laser light is being interrupted and reflected. The patterns of paint on the individual blade surfaces may thus “code” the rotating blades such that the operator and/or the automated system may determine where on the blade surface the laser light is being interrupted and reflected. The patterns may also aid in deriving certain blade properties, such as blade speed, blade flutter, and so on, as further described below. The term “paint” is used in the remainder of the application to broadly denote actual paint, coatings, surface finishes, or combinations thereof. Likewise, the term “painting” and/or “painted” is used to broadly denote painting, coating, surface finishing, or a combination thereof.

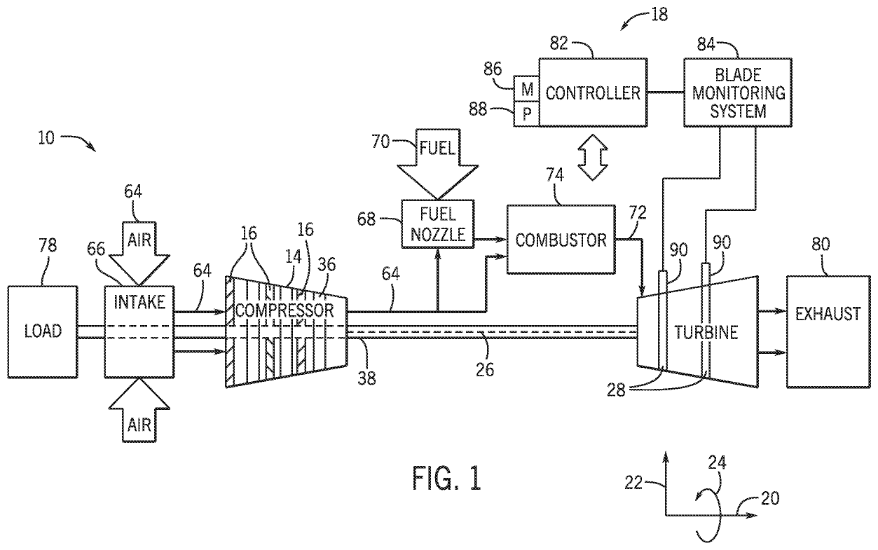

Turning now to the figures, FIG. 1 illustrates a block diagram of an embodiment of a gas turbine system 10 having a turbine 12 suitable for combusting a carbonaceous fuel to produce rotative power. Also shown is a compressor 14 equipped with vanes 16, and a control system 18. Throughout the discussion, a set of axes will be referenced. These axes are based on a cylindrical coordinate system and point in an axial direction 20, a radial direction 22, and a circumferential direction 24. For example, the axial direction 20 extends along a longitudinal axis 26 of the gas turbine system 10, the radial direction 22 is orthogonal to and extends away from the longitudinal axis 26, and the circumferential direction 24 extends around the longitudinal axis 26. Furthermore, it should be noted that while the present discussion will be focused on turbine blades 28, a variety of rotary equipment, such as compressors 14, pumps, and/or the like, may benefit from the techniques described herein.

An oxidant 64 flows from an intake 66 into the compressor 14, where the rotation of the compressor blades 16 compresses and pressurizes the oxidant 64. The oxidant 64 may include ambient air, pure oxygen, oxygen-enriched air, oxygen-reduced air, oxygen-nitrogen mixtures, or any suitable oxidant that facilitates combustion of fuel. The following discussion refers to air 64 as an example of the oxidant, but is intended only as a non-limiting example. The air 64 flows into a fuel nozzle 68. Within the fuel nozzle 68, fuel 70 mixes with the air 64 at a ratio suitable for combustion, emissions, fuel consumption, power output, and the like. Thereafter, a mixture of the fuel 70 and the air 64 is combusted into hot combustion products 72 within a combustor 74. The hot combustion products 72 enter the turbine 12 and force rotor blades 28 to rotate, thereby driving a shaft 38 into rotation. The rotating shaft 38 provides the energy for the compressor 14 to compress the air 64. More specifically, the rotating shaft 38 rotates the compressor blades 36 attached to the shaft 38 within the compressor 14, thereby pressurizing the air 64 that is fed to the combustor 74. Furthermore, the rotating shaft 38 may drive a load 78, such as an electrical generator or any other device capable of utilizing the mechanical energy of the shaft 38. After the turbine 12 extracts useful work from the combustion products 72, the combustion products 72 are discharged to an exhaust 80.

The control system 18 includes a controller 82 and a blade monitoring system 84. In some embodiments, the blade monitoring system 84 may be included in the controller 82, while in other embodiments the blade monitoring system 84 may be communicatively coupled to the controller 82. The controller 82 may include a memory 86 and one or more processors 88. The processor(s) 88 may be operatively coupled to the memory 86 to execute instructions for carrying out the presently disclosed techniques. These instructions may be encoded in programs or code stored in a tangible non-transitory computer-readable medium, such as the memory 86 and/or other storage. The processor(s) 88 may be a general purpose processor, system-on-chip (SoC) device, or application-specific integrated circuit, or some other processor configuration.

Memory 86 may include a computer readable medium, such as, without limitation, a hard disk drive, a solid state drive, a diskette, a flash drive, a compact disc, a digital video disc, random access memory (RAM), and/or any suitable storage device that enables processor(s) 88 to store, retrieve, and/or execute instructions and/or data. Memory 86 may further include one or more local and/or remote storage devices. Further, the controller 82 may be operably connected to a human machine interface (HMI), a display, and so on, to allow an operator to read measurements, perform analysis, and/or adjust operations of the gas turbine system 10.

In use, the blade monitoring system 84 may detect current properties or conditions of the blades 28 of the turbine 12, for example, by using data from sensors 90. For instance, the sensors 90 may include optical sensor systems and or magnetic sensor systems that sense certain markings disposed on the blades 28, as further described below. The updates from the sensors 90 may be received in real-time, e.g., at a rate between, 1-4,000 microseconds, 1-100 milliseconds. Blade 28 properties or conditions derived by the blade monitoring system 84 may be displayed to an operator and/or provided to the controller 82. The controller 82 may control operations of the gas turbine system 10, for example by controlling fuel flow 70, air flow 64, measuring exhaust 80 temperature, measuring load 78 properties (e.g., electrical power produced), and the like, during operations.

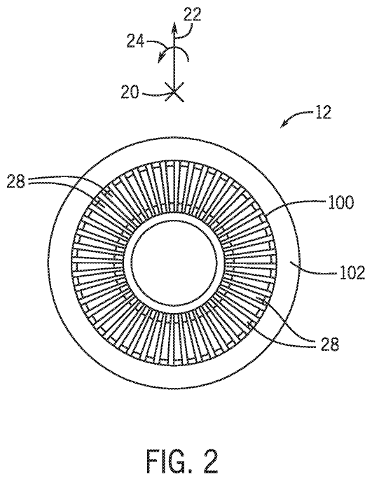

FIG. 2 illustrates a front view of an embodiment of a stage 100 of the turbine 12 depicting multiple blades 28. The turbine 12 may include one or more stages 100, each stage 100 having blades 28 suitable for being driven by the fluid product of combustion. Also shown is a stationary casing 102 surrounding the stage 100, as well as other stages not shown. In use, the blades 28 may rotate radially in the circumferential direction 24, thus producing rotative motion that may be converted into power via the load 78, such as an electrical generator. It may be beneficial to sense various properties and characteristics of the stage 100 and blades 28. For example, speed of each blade 28, any deformation (e.g., thermal deformation) in the blades 28, flutter in the blades 28, and so on. Accordingly, the techniques described herein provide for the sensors 90 to be disposed at one or more locations in the stationary casing 102. The sensors 90 may include optical sensors (e.g., laser-based sensors), magnetic sensors, and so on, which may sense certain markings.

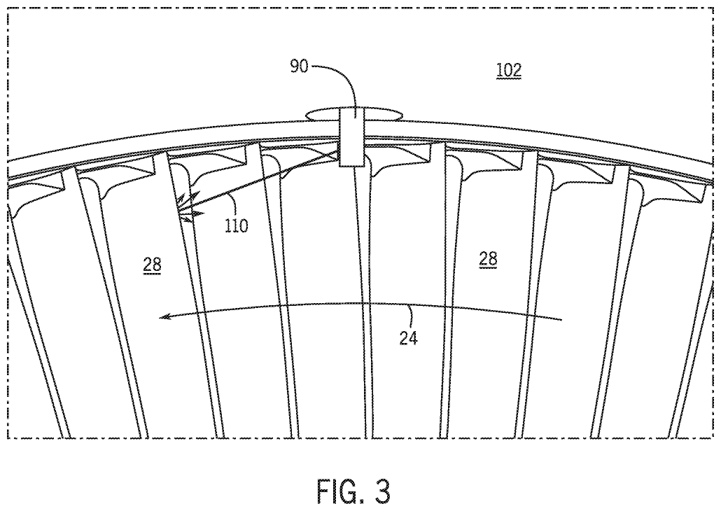

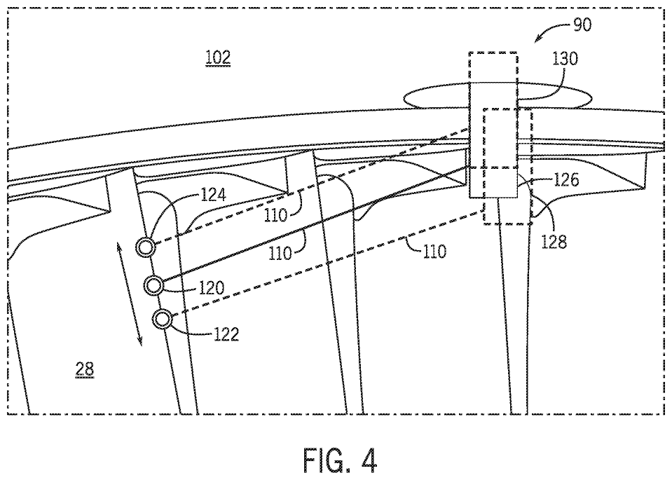

FIG. 3 is a detail front view of an embodiment of a single sensor 90 disposed in the stationary casing 102 and positioned to sense one or more of the blades 28. More specifically, the figure depicts the sensor 90 positioned to observe trailing edges of the blades 28 as they rotate in the circumferential direction 24. In the depicted embodiment, the sensor 90 may be an optical sensor that illuminates the blades 28 with laser light beam 110. The laser light beam 110 is shown as impinging an edge of the blade 28, and then reflecting off the blade 28. Light reflection may then be captured by the sensor 90 and used to derive various properties and conditions of the blade 28. However, during operations, an alignment between the sensor 90 and the blade 28 may shift, for example, because of thermal changes. Accordingly, a point of impact or impingement for the laser light beam 110 may shift, as shown in FIG. 4.

More specifically, FIG. 4 depicts an embodiment of the blade 28 showing three impingement points 120, 122, 124 which may shift during operations of the gas turbine system 10. For example, when the gas turbine system 10 is in a “cold” state, such before startup operations, the point 120 may reflect light incoming from sensor 90 at position 126. As the gas turbine system 10 enters baseload operations, thermal changes, vibration, and so on, may cause the blade 28 and/or the sensor 90 to shift positions with respect to each other. For example, sensor 90 may shift to position 128, which may now cause impingement of light beam 110 at point 122. Likewise, the sensor 90 may sift to position 130, causing impingement of light beam 110 at point 124.

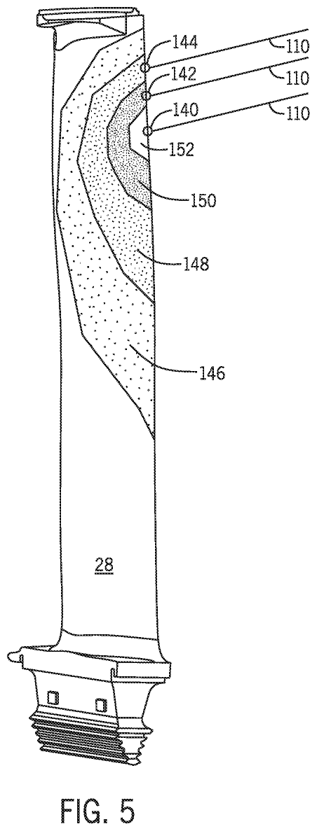

The shifting of impingement points (e.g., points 120, 122, 124) may lead to inaccuracies in measurement. For example, FIG. 5 illustrates an embodiment of the blade 28 depicting shifting impingement points 140, 142, 144 for the light beam 110. In the depicted embodiment, the blade 28 may be undergoing a condition referred to as blade flutter. During blade flutter, self-excited vibration of blades may typically be caused by the interaction of structural-dynamic and/or aerodynamic forces. For example, blade areas or portions 146, 148, 150 may experience different stresses with respect to each other, which may cause certain areas or portions of the blade 28 to vibrate.

In the depicted embodiment, the sensor 90 may be used to measure displacement of the blade 28. However, because the light beam 110 may now impinge at different locations, it would be beneficial to derive where the light beam 110 is impinging, e.g., radially along direction 24 in real-time. The techniques described herein include the use of certain markings, as further described below, that may be used to determine where the light beam 110 may now be impinging, as well as to provide for derivation of blade 28 properties and conditions.

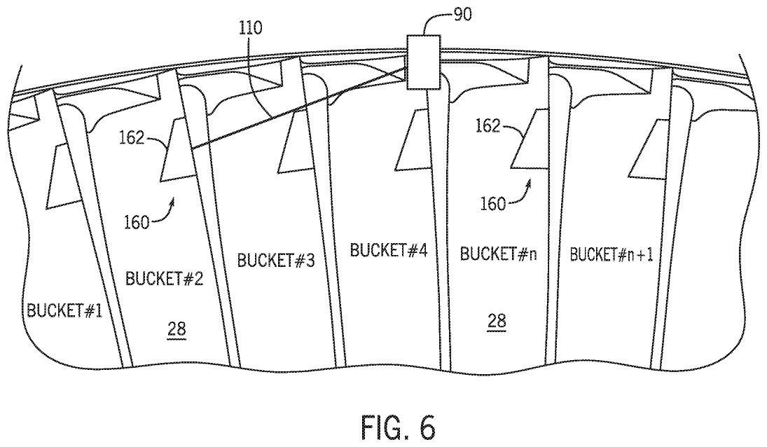

Turning now to FIG. 6, the figure is a detail front view of an embodiment of blades 28 (also referred to as “buckets”) with various markings 160 disposed on the edge of the blades 28. It is to be understood that while the markings 160 are shown as being disposed on the blade's trailing edge, the markings 160 may be disposed on a top of the blades, e.g., blade portion that is closest to stationary casing 102, or on other areas of the blade 28 (e.g., leading edge). In the depicted embodiment, the markings 160 include a sloping section 162 that may enable a more accurate measure of, for example, positional shifting between the sensor 90 and the blades 28.

For example, because the marking 160 includes the sloping section (e.g., taper) 162, as the blade 28 rotates, differing reflects light differently than a remainder of the blade 28, a blade carrying the marking 160 may be uniquely marked when compared to a blade not carrying the marking 160, such as a single unmarked blade. Further as impingement points shift, the shift may be detected as the shift may now result in differing signals coming back to the sensor 90, as described in more detail below. It is to be noted that the sloping section 162 is illustrated as a straight line. However, the sloping section 162 may include a curve, such as a curve having the same start/end points as the sloping section 162 but dipping either below the sloping section 162 or above the slopping section 162.

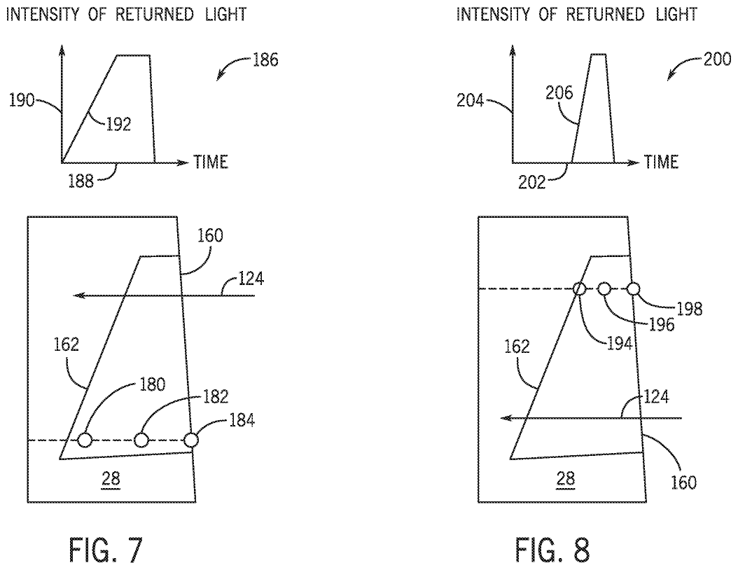

FIG. 7 illustrates an embodiment of impingement points 180, 182, 184 on the blade 28 that may then result in an embodiment of a graph 186 depicting time in an X axis 188 versus an intensity of returned light from the beam 110 in a Y axis 190. More specifically, as the blade 28 rotates in the direction 24, the sensor 90 may receive data reflected first off impingement point 180, followed by point 182, and then point 184. As illustrated, the points 180, 182, 184 are located at a wider section of the marking 160 near a bottom of the marking 160. Accordingly, the graph 186 illustrates a curve 192 corresponding to the light intensity of returned light 110 read by the sensor 90 during traversal of the blade 28 through the sensing area(s).

As the blade 28 and sensor 90 shift positions with respect to each other, for example due to thermal dynamics, blade flutter, and so on, the impingement points may shift. For example, FIG. illustrates an embodiment of shifted impingement points 194, 196, 198 on the blade 28 that may then result in an embodiment of a graph 200 depicting time in an X axis 202 versus an intensity of returned light from the beam 110 in a Y axis 204. More specifically, as the blade 28 rotates in the direction 24, the sensor 90 may receive data reflected first off the first shifted impingement point 194, followed by point 196, and then point 198.

As illustrated, the points 194, 196, 198 are located at a narrow section of the marking 160 near a top of the marking 160. Accordingly, the graph 200 illustrates a curve 206 corresponding to the light intensity of returned light 110 read by the sensor 90 during traversal of the blade 28 through the sensing area(s) as a position between the sensor 90 and the blade 28 has shifted. As illustrated, the curve 206 may include a steeper slope and/or a smaller area under the curve when compared to the curve 192. By analyzing intensity of returned light curves, such as curves 192, 206, the controller 50 (or a computing system) may derive an amount as well as a position of the shift, including the position of the new impingement points after the shift. Accordingly, more precise measurements may now be provided.

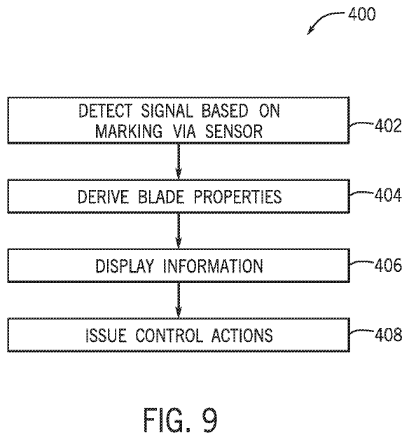

FIG. 9 is a flowchart depicting an embodiment of a process 400 suitable, for example, to derive certain information via the markings 160 as well as to apply the derived information for display and/or control. The process 400 may be implemented as computer code or instructions executable, for example, by the processor 86 and stored in memory 88 (or by a computing device which may be communicatively coupled to the sensor(s) 90 and/or receive data sensed via sensor(s) 90). In the depicted embodiment, the process 400 may first detect (block 402), for example in real time, a signal as a marked blade 28 passes through a sensing region of the sensor 90. As mentioned above, the process 400 may sense the marking(s) 160 as blades 28 enter the sensing region.

In some embodiments, the process 400 may then derive (block 404) certain blade properties and/or characteristics. For example, blade speed in RPM may be derived, as well as actual location of impingement points for the light beam 110 may be determined. Blade flutter measurements, for example, may then be made more precise, and expansion/contraction of blade 28 material and/or stationary casing 102 may be determined. In some embodiments, each of the blades 28 may be uniquely identified. As mentioned above, unique blades may be identified through the use of an unmarked blade 28 while the other blades 28 have markings 160. The process 400 may then display (block 408) information related to the markings 160, including the properties and/or characteristics derived in block 406. For example, blade speed for each blade number may be displayed, blade flutter measures may be displayed, shifting of impingement points may be displayed, including location of new impingement points, and so on.

The process 400 may then issue (block 410) certain control actions, such as adjusting fuel flow, air flow, inlet guide van angles, and so on, based on the properties and/or characteristics derived in block 406. Because the derivations (e.g., derivations of block 406) may lead to more accurate measures, adjustments to blade 28 speed via fuel adjustments, air flow adjustments, inlet guide vane adjustments, and so on, may result in improved control of the gas turbine engine 12 and the power production system 10. By applying the markings 160, the techniques described herein may provide for improved blade measurements via the sensors 90, which may include optical and/or magnetic sensors. It is also to be understood that while the techniques are described in view of gas turbine blades, other bladed turbine machinery, such as compressors, wind turbines, hydroturbines, expanders, and so on, may be used with the techniques described herein.

Technical effects include blade markings having continuous features, such as a taper. The taper may be used to derive improve location information on beam impingement, magnetic pickup, or a combination thereof, as a position between a blade and a sensor shift, for example due to thermal changes. The information derived via the discretely marked blade may be used to improve accuracy in measurements such as more accurate blade flutter measurements, blade dynamic changes, individual blade speed, and so on.

This written description uses examples to disclose the present techniques, including the best mode, and also to enable any person skilled in the art to practice the techniques, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A blade monitoring system of turbomachinery, comprising:
a processor configured to:
receive a sensor signal from a sensor configured to observe a blade of the turbomachinery;
derive a measurement based on a marking disposed on the blade of the turbomachinery, wherein the marking comprises a continuous feature; and
display the measurement to an operator of the turbomachinery.

2. The system of claim 1, wherein the continuous feature comprises a taper.

3. The system of claim 2, wherein the taper comprises a straight segment having a slope.

4. The system of claim 3, wherein the slope comprises a positive slope when the continuous feature is viewed from a frontal view of the blade.

5. The system of claim 2, wherein the taper comprises a curved segment.

6. The system of claim 1, wherein the processor is configured to:
receive a second sensor signal from the sensor configured to observe the blade of the turbomachinery, wherein the second sensor signal is representative of a shift in a position between the blade and the sensor;
derive a second measurement based on a second sensor signal; and
display the second measurement to the operator of the turbomachinery.

7. The system of claim 6, wherein the position comprises a different lengthwise location of impingement of light from the sensor.

8. The system of claim 1, wherein the measurement comprises a unique identification measurement identifying the blade from other blades in a stage of the turbomachinery.

9. The system of claim 1, wherein the measurement comprises a location of a light beam, a blade flutter measurement, a shift of position between the blade and the sensor measurement, or a combination thereof.

10. The system of claim 1, wherein the turbomachinery comprises a gas turbine and wherein the blade is disposed in a stage of the gas turbine.

11. A turbomachinery system, comprising:
a blade configured to rotate during operations of the turbomachinery system;
a sensor configured to observe the blade of the turbomachinery; and
a blade monitoring system, comprising:
a processor configured to:
receive a sensor signal from the sensor configured to observe the blade of the turbomachinery system;
derive a measurement based on a marking disposed on the blade of the turbomachinery system, wherein the marking comprises a continuous feature; and
display the measurement to an operator of the turbomachinery system.

12. The system of claim 11, wherein the continuous feature comprises a taper.

13. The system of claim 12, wherein the taper comprises a straight segment having a slope.

14. The system of claim 13, wherein the slope comprises a positive slope when the continuous feature is viewed from a frontal view of the blade.

15. The system of claim 11, wherein the processor is configured to:
receive a second sensor signal from the sensor configured to observe the blade of the turbomachinery, wherein the second sensor signal is representative of a shift in a position between the blade and the sensor;
derive a second measurement based on a second sensor signal; and
display the second measurement to the operator of the turbomachinery.

16. A method, comprising:
receiving, via a processor, a sensor signal from a sensor configured to observe a blade of a turbomachinery;
deriving, via the processor, a measurement based on a marking disposed on the blade of the turbomachinery, wherein the marking comprises a continuous feature; and
displaying the measurement to an operator of the turbomachinery.

17. The method of claim 16, wherein the wherein the continuous feature comprises a taper.

18. The method of claim 17, wherein the taper comprises a straight segment having a slope.

19. The method of claim 18, wherein the slope comprises a positive slope when the continuous feature is viewed from a frontal view of the blade.

20. The method of claim 16, comprising:
receiving a second sensor signal from the sensor configured to observe the blade of the turbomachinery, wherein the second sensor signal is representative of a shift in a position between the blade and the sensor;
deriving a second measurement based on a second sensor signal; and
displaying the second measurement to the operator of the turbomachinery.
